(19) United States
(12) Patent Application Publication
(10) Pub. No.: US 2013/0120998 A1
(43) Pub. Date: May 16, 2013

(54) HEAT SINK FOR A LIGHT SOURCE

(71) Applicants: Bernd Oehle, Rheda-Wiedenbruck (DE); Stephan Pieper, Lemgo (DE)

(72) Inventors: Bernd Oehle, Rheda-Wiedenbruck (DE); Stephan Pieper, Lemgo (DE)

(73) Assignee: Zumtobel Lighting GmbH, Lemgo (DE)

(21) Appl. No.: 13/580,763

(22) PCT Filed: Feb. 23, 2011
(86) PCT No.: PCT/EP2011/052647

§ 371 Date: Oct. 9, 2012

(30) Foreign Application Priority Data
Feb. 23, 2010 (DE) 10 2010 002 235.7

(51) Int. Cl. F21V 29/00

(52) U.S. Cl. CPC F21V 29/22
USPC 362/257; 29/428

(57) ABSTRACT

The invention relates to a heat sink for a light source, in particular an LED light source, said heat sink comprising an annular outer body and a central body which is formed by a separate element and is arranged in a central opening of the outer body.

The present invention relates to a heat sink provided for cooling a light source. In particular, the invention relates to a heat sink for an LED light source, wherein the heat sink with the light source can constitute, for example, part of a so-called downlight.

Recently, LED-based light sources have also been used increasingly in lighting applications. The luminous intensities that can be achieved with LEDs have in the meantime been so high that in almost all cases light sources used previously—for example incandescent bulbs or fluorescent lamps—can be replaced by LEDs. LEDS have significant advantages in this connection with regard to their operational reliability and also the possibilities for activation.

On the other hand, the utilization of LEDs for lighting purposes entails the problem that effective measures have to be employed to cool the light sources. The heat loss that occurs during the operation of LEDs is comparatively high and, furthermore, also concentrated in a small region so that in order to avoid damage measures have to be taken in order to dissipate the heat quickly and effectively. Usually, heat sinks which communicate thermally with the LEDs are employed for this.

A classic heat sink usually consists of metal—in particular aluminium—and is formed in such a way that it constitutes a large contact area with the surroundings. For this, the heat sink is as a rule formed in the manner of lamellae or is provided with corresponding lamellae or cooling ribs. Such a structure, however, is comparatively complex, which is why previously heat sinks were in the first place constructed as aluminium die-cast bodies. The outlay on the production of such aluminium die-cast bodies is comparatively high and accordingly associated with high costs. Furthermore, such heat sinks are also of a not inconsiderable weight.

The underlying object of the present invention is to provide a novel heat sink for cooling light sources that has good cooling properties and at the same time can be produced in a comparatively simple and cost-effective manner.

The object is achieved by means of a heat sink having the features of claim 1 and also by means of a method for producing a heat sink according to claim 7. Advantageous further developments of the invention constitute subject matter of the dependent claims.

The aluminium die-cast bodies mentioned above that were used previously as heat sinks are as a rule one-piece elements. In contrast, in accordance with the invention it is proposed that the heat sink be formed in multiple parts, in particular in two parts. For this, it has a ring-like outer body and also a central body that is formed by a separate element and is arranged in a central opening of the outer body.

In accordance with the present invention accordingly a heat sink for a light source, in particular for an LED light source, is proposed, wherein the heat sink has a ring-like outer body and also a central body that is formed by a separate element and is arranged in a central opening of the outer body. In accordance with the present invention, a method for constructing a heat sink for a light source, in particular for an LED light source, is also proposed, wherein in the first instance a ring-like outer body having a central opening is provided, and subsequently a central body is inserted into the opening.

The central body preferably forms a planar supporting surface for the light source. For this, in particular it can also have means for securing the light source. These can be formed, for example, by means of bore holes or the like.

The outer body and the central body are preferably joined together by shrinking the outer body onto the central body. As a result, full-surface contact is guaranteed that renders possible good transmission of the heat from the central body to the outer body.

The subdivision of the heat sink in accordance with the invention opens up the possibility in particular of producing the outer body using the extrusion method. This procedure is significantly simpler and more cost-effective than the die-casting method, which is why the costs of production for the heat sink can be significantly reduced. Also a reduction in weight of the heat sink is attained, with consistently good cooling properties. The central body itself is preferably formed as a solid-material body in order to optimize the dissipation of the heat issuing from the light source.

The invention shall be explained in greater detail in the following with reference to the enclosed drawing, in which:

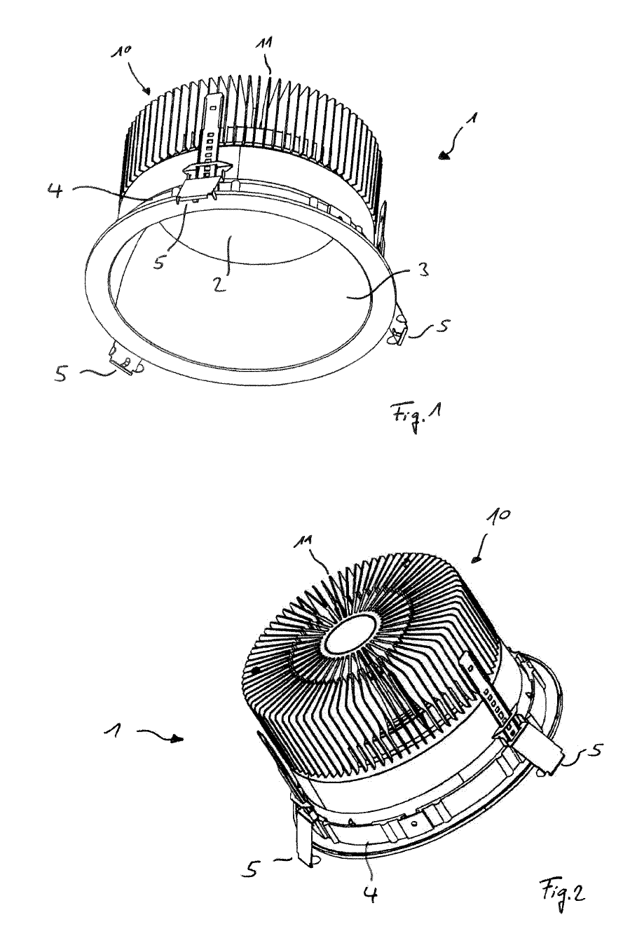

FIGS. 1 and 2 show views of a built-in luminaire in the form of a so-called downlight, in which the heat sink in accordance with the invention is employed;

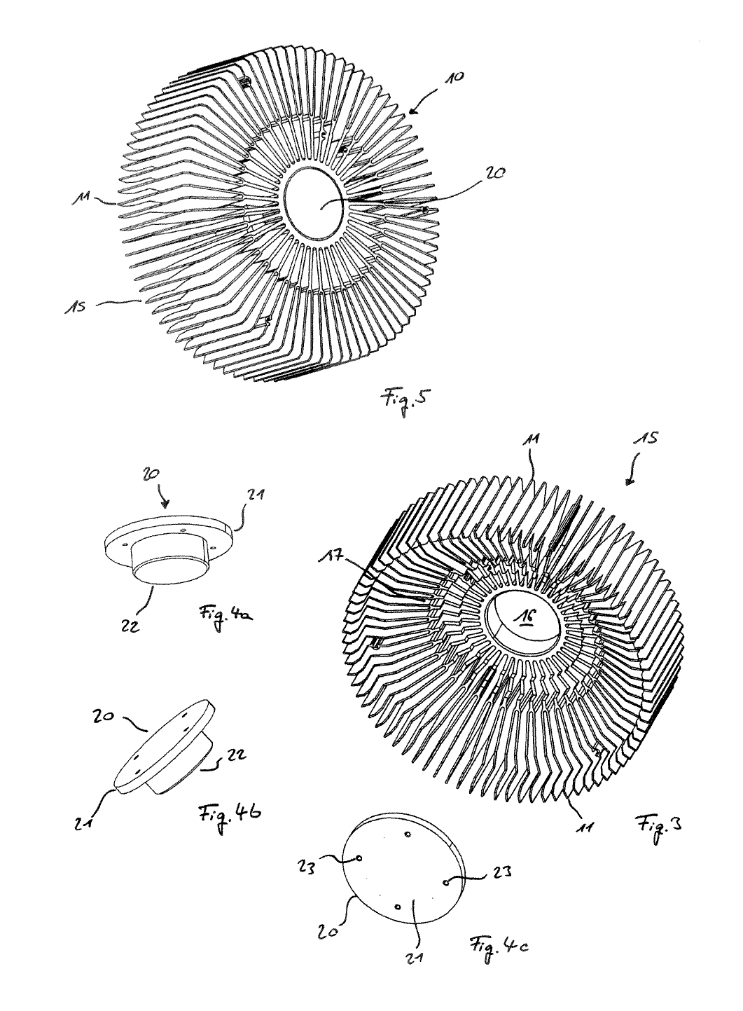

FIG. 3 shows a view of the outer body of the heat sink in accordance with the invention;

FIGS. 4a to 4c show views of a central body of the heat sink in accordance with the invention;

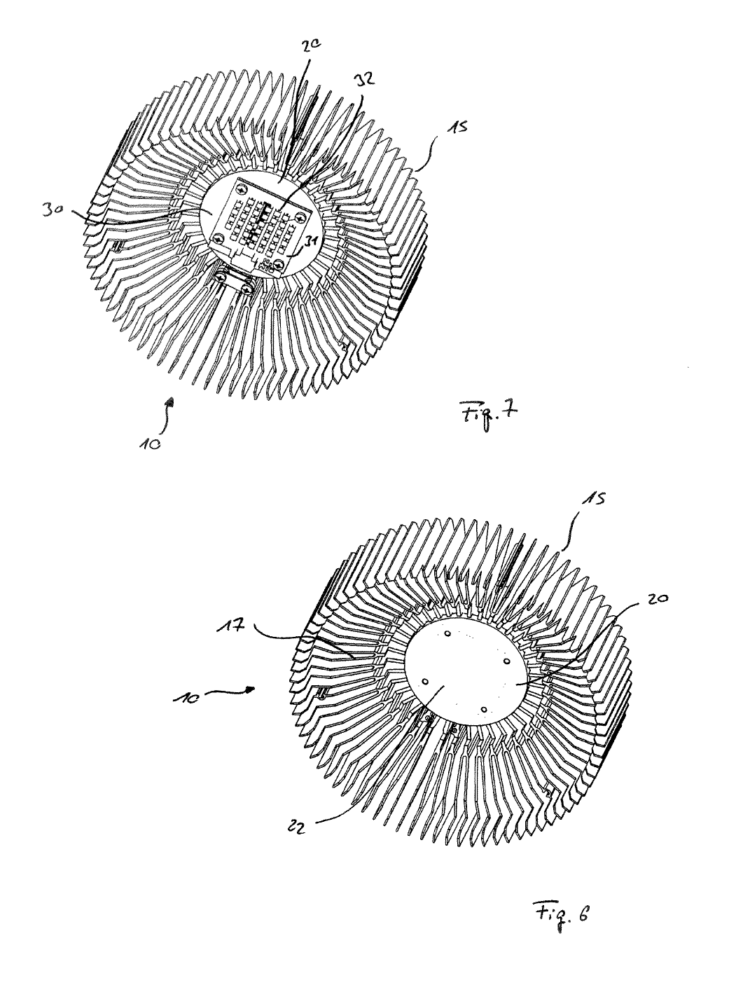

FIGS. 5 and 6 show views of the heat sink formed by the outer body and central body; and

FIG. 7 shows a view of a heat sink in accordance with the invention with an LED light source secured thereon.

The heat sink in accordance with the invention is used in the case of the exemplary embodiment described in the following in the case of a so-called downlight, that is, a built-in luminaire mounted in the circular opening of a ceiling. The properties of the heat sink have a particularly advantageous effect in the case of such an application. At the same time, it is to be pointed out that the heat sink in accordance with the invention could also be employed in the case of other types of luminaires.

In the case of the downlight 1 shown in FIGS. 1 and 2 the heat sink 10 represents the central element of the luminaire. In particular, the heat sink 10 is also used at the same time to hold further elements of the luminaire 1.

The heat sink 10 has the form of a flat cylinder and over its circumferential region is provided with numerous lamellae or cooling ribs 11 by means of which the surface is enlarged. A heat exchange with the surroundings is optimized by means of this surface-enlargement.

The heat sink 10 is used, furthermore, to mount a light source which in the present case in particular is an LED light source. In particular, for this—as described in greater detail in the following—a plurality of LEDs can be arranged in the manner of a matrix on a printed circuit board. Since the LEDs themselves represent almost punctiform light sources, in order to even out the light-emission an optical element 2, for example a diffusing screen, is arranged in front of the LEDs. As a result, the individual so-called hotspots brought about by the LEDs are dispersed, and the appearance of a brightly and uniformly illuminating surface results. The light-emission to the lower side is then effected by way of a pot-shaped reflector 3 which is coupled by its upper side to the heat sink 10 and defines with its lower side a circular light-outlet opening. The structural unit consisting of the heat sink 10 and reflector 3 is secured in a ceiling with the aid of an assembly ring 4 which is first inserted into the ceiling opening and fixed there by means of three latching arms 5 that can be swivelled out. Subsequently, the luminaire 1 is inserted from the lower side into this assembly ring 4 and fixed, for example, by turning. Such assembly systems for downlights are already sufficiently well known and accordingly shall not be explained in greater detail in the following.

The special feature of the heat sink 10 lies in its configuration and shall be described in the following. In accordance with the invention, the heat sink 10 is formed in two portions and consists, on the one hand, of an annular outer body 15, which is shown in FIG. 3, and also of a central body 20, which is shown in FIGS. 4a to 4c.

The annular outer body 15 substantially consists of a circular arrangement of lamellae or ribs 11 that extend laterally from a central opening 16 over the circumference. The lamellae 11 can—as shown in FIG. 3—branch again in a Y-shaped manner on the way towards the outside, thereby attaining an additional enlargement of the surface. At their inner circumference the lamellae 11 enclose the opening 16 that has already been mentioned and is formed in a circular manner.

The outer body 15 shown in FIG. 3 can be produced in a simple manner in the course of an extrusion method. This method is significantly simpler and more cost-effective to carry out than production using the aluminium die-casting method. In the extrusion method ultimately a metal body that has the cross-sectional configuration shown in the figures is constructed with a greater length. This rod-like structure need then only merely be cut off to the corresponding length of the heat sink. Furthermore, then by means of removing methods, for example milling or the like, the outer body is provided with a depression 17 which is used for the arrangement of the light source and also of a reflector, which is not shown in greater detail.

The second element that ultimately forms the heat sink 10 is the central body 20, shown in FIGS. 4a to 4c, which is preferably a solid-material body formed in particular in one piece. It has in the first instance a larger disc 21, on one side of which a cylindrical projection 22 is arranged. The outer contour of the projection 22 corresponds to the opening 16 of the outer body 15 so that the central body 20 can be inserted into the outer body 15, as described in the following, with an exact fit. The central body 20 is then preferably secured to the outer body 15 by being shrunk thereon. For this, the outer body 15 is first heated so that it expands slightly, and in particular the cross-sectional area of the through-opening 16 is enlarged. In this state, the cylindrical projection 22 of the central body 20 can be inserted into the opening 16. Subsequently, the outer body 15 is cooled and hereby shrinks onto the projection 22 of the central body 20. This procedure allows both elements to be connected together without the use of additional aids. At the same time, full-surface contact of both elements is ensured, whereby optimum heat-transmission is guaranteed.

Instead of the circular form shown for the through-opening 16 and also for the projection 22, of course other cross-sectional forms could also be chosen. The configuration shown, however, brings advantages with it with regard to the production of the elements.

After the central body 20 has been inserted into the outer body 15, the arrangement shown in FIGS. 5 and 6 then results; it can be inferred in particular from FIG. 6 that the plate 21 of the central body 20 now forms a planar base surface of the recess 17. This can be used for the arrangement of a light source 30, as shown in FIG. 7. The light source 30 is formed in the exemplary embodiment shown by means of a plurality of LEDs 32 arranged together on a printed circuit board 31. Full-surface contact with the printed circuit board 31 is guaranteed by means of the plate 21 of the central body 20 so that optimum thermal coupling is attained. The printed circuit board 31 is secured to the central body 20 with the aid of four screws 32 which engage into corresponding bore holes 23 on the plate 22. In this case, heat-transmission can be additionally optimized by providing a thermally conductive material, for example a corresponding paste or the like, between the printed circuit board 31 and the supporting plate 21. In each case, [ . . . ] the embodiment shown there is effective thermal coupling between the light sources and the heat sink 10. As indicated, furthermore, in FIG. 7, there can be secured on the circumference of the supporting plate 21, furthermore, a tension-relief arrangement 35 by way of which cables leading to the LED printed circuit board 31 can be fixed.

Ultimately, by means of the present invention a heat sink is provided, which, on the one hand, can be produced simply and cost-effectively and, on the other hand, guarantees optimum heat-transmission or dissipation of the heat generated by a light source.

1. A heat sink for a light source, in particular for an LED light source, wherein the heat sink has a ring-like outer body and also a central body that is formed by a separate element and is arranged in a central opening of the outer body.

2. The heat sink according to claim 1, wherein the central body forms a preferably planar supporting surface for the light source.

3. The heat sink according to claim 1, wherein the central body has means to secure the light source, in particular bore holes.

4. The heat sink according to claim 1, wherein the outer body is shrunk onto the central body.

5. The heat sink according to claim 1, wherein the outer body is formed by an extruded profile and has a plurality of cooling ribs directed to the outside.

6. The heat sink according to claim 1, wherein the central body is formed as a solid-material body.

7. A method for constructing a heat sink for a light source, in particular for an LED light source, wherein in the first instance a ring-like outer body having a central opening is provided, and a central body is inserted into the opening.

8. The method according to claim 7, wherein the outer body is shrunk onto the central body.

9. The method according to claim 7, wherein the outer body is produced using the extrusion method.
